(19) United States
(12) Patent Application Publication
(10) Pub. No.: US 2026/0006073 A1
(43) Pub. Date: Jan. 1, 2026

(54) ACCELERATED DETECTION OF SPEAR PHISHING DURING EMAIL MALWARE DETECTION ON ENTERPRISE NETWORKS

(71) Applicant: Fortinet, Inc., Sunnyvale, CA (US)

(72) Inventors: Haitao Li, Coquitlam (CA); Lisheng Ryan Sun, Burnaby (CA)

(73) Assignee: Fortinet, Inc., Sunnyvale, CA (US)

(21) Appl. No.: 18/756,021

(22) Filed: Jun. 27, 2024

(51) Int. Cl. H04L 9/40

(52) U.S. Cl. CPC H04L 63/1483

(57) ABSTRACT

Emails suspected to include a spear phishing attack are identified from the stream of incoming emails using a Related Anomaly Score (RAS). The RAS is calculated by identifying feature vectors from the stream of incoming emails associated with a sender of the email and a link of the email. The suspicious spear phishing emails are mapped by feature vectors and prioritizing according to map position. For reliability, in one case, relative distances are calculated between suspicious emails, and if a relative distance between the specific email and prioritized suspicious emails exceeds a predetermined distance threshold, take a security action based on spear phishing rules on the filtered highest suspicious emails, and if the relative distance does not exceed the predetermined distance threshold, take a second security action including forwarding the specific email for standard phishing analysis.

### FIELD OF THE INVENTION

The invention relates generally to computer networks, and more specifically, for accelerated detection of spear phishing during email malware detection associated with an enterprise network.

### BACKGROUND

In recent years, a sequence of prominent security breaches has underscored the increasing prevalence and effectiveness of spear phishing attacks. In contrast to malware exploits focusing on technical vulnerabilities in software and protocols, phishing attacks try to scam large groups of people to comprise sensitive data.

Spear phishing generally constitutes a form of social engineering attack. In this strategy, the assailant sends a tailored, misleading email to the target, coaxing them into undertaking actions detrimental to their own security. From the perspective of defenders, countering spear phishing proves challenging due to email's vulnerability to spoofing and the meticulous crafting of deceptive emails by attackers, rendering them difficult to distinguish from legitimate communications. Presently, there is a lack of widely effective tools for the detection or prevention of spear phishing, establishing it as the primary method for breaching high-value targets.

While machine-learning techniques prove effective in numerous detection tasks, their efficacy is compromised in the context of spear phishing. Firstly, the limited size of available labeled training sets hampers effective model training. Secondly, dealing with super imbalanced data, where, for instance, only 1 in a million emails is a spear phishing attempt, requires an exceptionally low false positive rate. Even a low False Positive Rate (FPR), such as 0.1%, deemed satisfactory for general machine learning algorithms, still results in an unacceptably high volume of alerts for end-users.

What is needed is a robust technique for accelerated detection of spear phishing during email malware detection associated with an enterprise network.

### SUMMARY

To meet the above-described needs, methods, computer program products, and systems for accelerated detection of spear phishing during email malware detection associated with an enterprise network.

In one embodiment, a specific email is received from a stream of incoming emails destined for a specific user of a specific organization, wherein the stream of emails are received over a predetermined sliding window. Emails suspected to include a spear phishing attack are identified from the stream of incoming emails using a Related Anomaly Score (RAS). The RAS is calculated by identifying feature vectors from the stream of incoming emails associated with a sender of the email and a link of the email.

In another embodiment, the suspicious spear phishing emails are mapped by feature vectors and prioritizing according to map position. For reliability, in one case, relative distances are calculated between suspicious emails, and if a relative distance between the specific email and prioritized suspicious emails exceeds a predetermined distance threshold, take a security action based on spear phishing rules on the filtered highest suspicious emails, and if the relative distance does not exceed the predetermined distance threshold, take a second security action including forwarding the specific email for standard phishing analysis.

Advantageously, network security and computer performance is improved with faster and less resource intense phishing detection. Faster deployment is possible because training is not required.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for accelerated detection of spear phishing during email malware detection associated with an enterprise network, according to some embodiments.

FIG. 2 is a more detailed block diagram illustrating a network security device of the system of FIG. 1, according to an embodiment.

FIG. 3A is a flow diagram illustrating feature vectors used in RAS mapping of the system of FIG. 1, according to an embodiment.

FIG. 3B is a graph illustrating the RAS mapping of the system of FIG. 1, according to an embodiment.

FIG. 4 is a high-level flow diagram illustrating a method for accelerated detection of spear phishing during email malware detection associated with an enterprise network, according to an embodiment.

FIG. 5 is a more detailed diagram illustrating a step of RAS mapping, from the method of FIG. 5, according to an embodiment.

FIG. 6 is a block diagram illustrating an example computing device for the system of FIG. 1, according to an embodiment.

### DETAILED DESCRIPTION

Methods, computer program products, and systems for automatically associating a surveillance security policy with a user on video based on Wi-Fi data. The following disclosure is limited only for the purpose of conciseness, as one of ordinary skill in the art will recognize additional embodiments given the ones described herein.

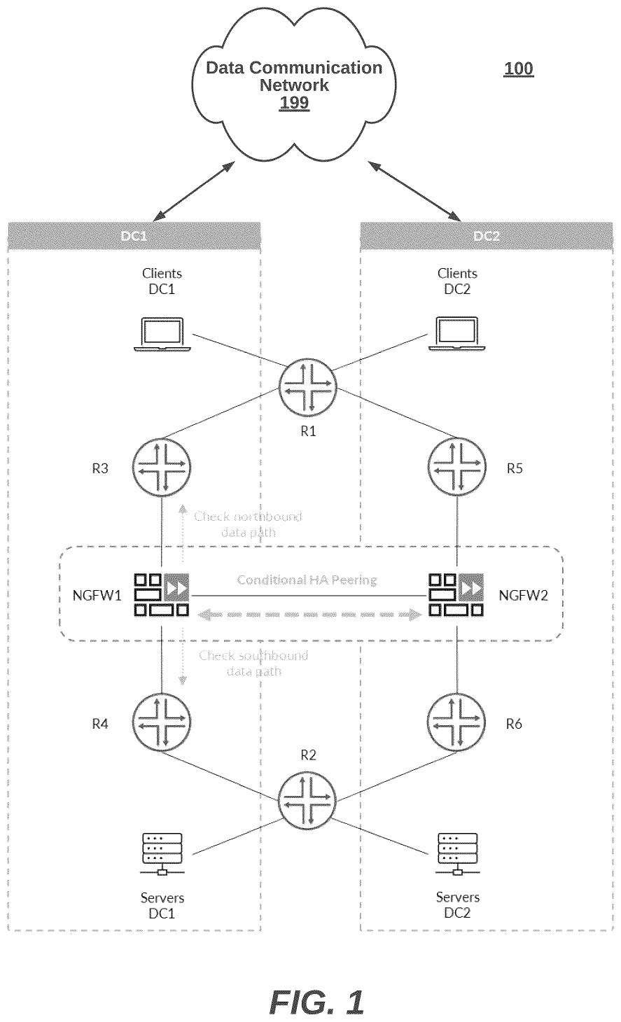

### I. Systems for Accelerated Spear Phishing Detection (FIGS. 1-3)

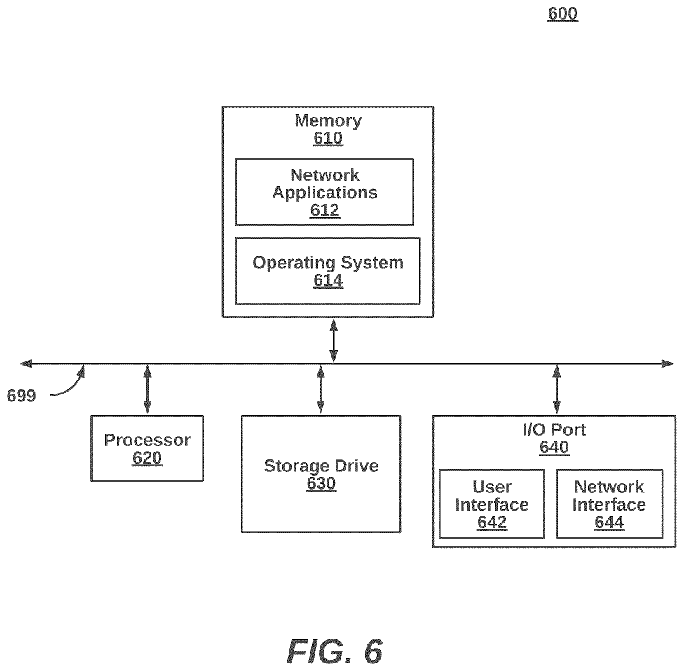

FIG. 1 is a high-level block diagram illustrating a system 100 for accelerated detection of spear phishing during email malware detection associated with an enterprise network, according to an embodiment. The system 100 includes a network security device 110, an email server 120 a plurality of enterprise stations 130A-C, each associated with a person, and a malicious device 140 on a data communication network 199. Other embodiments of the system 100 can include additional components that are not shown in FIG. 1, such as routers, switches, network gateways, and firewalls, and access points. Further, there can be more security devices (e.g., distributed or cloud-based), enterprise stations and malicious devices. The components of system 100 can be implemented in hardware, software, or a combination of both. An example implementation is shown in FIG. 6.

In one embodiment, the components of the system 100 are coupled in communication over a private network connected to a public network, such as the Internet. In another embodiment, system 100 is an isolated, private network, or alternatively, a set of geographically dispersed LANs. The components can be connected to the data communication system via hard wire (e.g., network security device 110 and email server 120). The components can also be connected via wireless networking (e.g., enterprise stations 130A-C). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPV4 or Ipv6 address spaces.

In one embodiment, the network security device 110 protects the enterprise network against malware, and has specific processes to identify spear phishing attacks contained within email. Generally, spear phishing is a type of attack that uses malicious emails to target specific individuals or organizations to steal sensitive information or infect their devices with malware. The network security device 110 can quickly check for spear phishing, with reduced effort, before invoking more thorough checks. For example, standard phishing and malware checks can be bypassed altogether. Alternatively, standard checks can be invoked as needed, such as when accelerated spear phishing detection is not able to reliable make a determination. Advantageously, resources are conserved when standard phishing or malware can be avoided. Furthermore, standard algorithms with machine learning, artificial intelligence or prediction modeling often requires training data that is not available for new systems or rare types of emails.

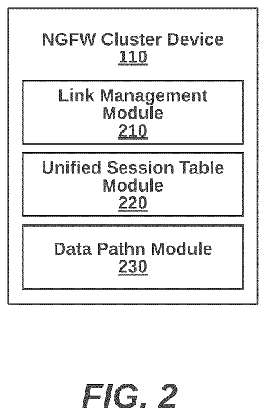

The network security device 110 of FIG. 1 is disposed locally on enterprise network. In other embodiments, the network device 110 is disposed on the data communication network 199 as a remote or cloud-based device which may be operated by a third-party. On the enterprise network, the network device 110 can be a gateway, an access point, a firewall, or a router, for example. The network device 110 may be a dedicated device or integrated to perform other network functions. In another embodiment, the network device 110 is distributed among several network components that cooperate (e.g., local executing daemons). Additional embodiments of the network security device 110 are set forth below in association with FIG. 2

The email server 120 can comprise a Mail Transfer Agent (MTA) server, a Simple Mail Transfer Protocol (SMTP) server, or the like, that stores emails for trusted users. The SMTP is a technical standard for transmitting email over a network. This allows computers and servers to exchange data regardless of their underlying hardware or software. A user can log-in to the email server 120 from a user device using, for example, a username and a password. Separate protocols can be used to retrieve email from the email server, such as Internet Message Access Protocol (IMAP) or Post Office Protocol (POP).

In some embodiments, the email server 120 scans incoming emails for standard phishing emails before being exposed to users, after accelerated scanning for spear phishing. In other cases, a bypass flag associated with the email indicates that scanning is not needed.

The enterprise stations 130A-Ccan be a personal computer, a laptop, a smartphone, a tablet, a terminal, or any other appropriate processor-driven device for email services. An email client is a user application, such as a web browser, Outlook, or the like can retrieve and display email from the email server 120. Users can compose new emails, retrieve stored emails, and forward and reply to stored emails.

FIG. 2 is a more detailed block diagram illustrating the network device 110 of the system of FIG. 1, according to one embodiment. The phishing email database 110 includes a queue module 210, an RAS module 220, an email prioritizing module 230 and a security action module 240. The components can be implemented in hardware, software, or a combination of both.

The queue module 210 can receive a specific email from a stream of incoming emails destined for a specific user of a specific organization. The stream of emails are received over a predetermined sliding window.

The RAS score module 220 identifies emails suspected to include a spear phishing attack from the stream of incoming emails using a RAS. The RAS is calculated by identifying feature vectors from the stream of incoming emails associated with a sender of the email and a link of the email. Each feature vector can include several dimensions. In one embodiment, the features include link reputation and sender reputation. The vectors of the link reputation can include IP-based URLs, age of linked-to domains and domain visits. The vectors of sender reputation can include different HTML <Head> content and different sending server. More specifically:

### A. Link Reputation

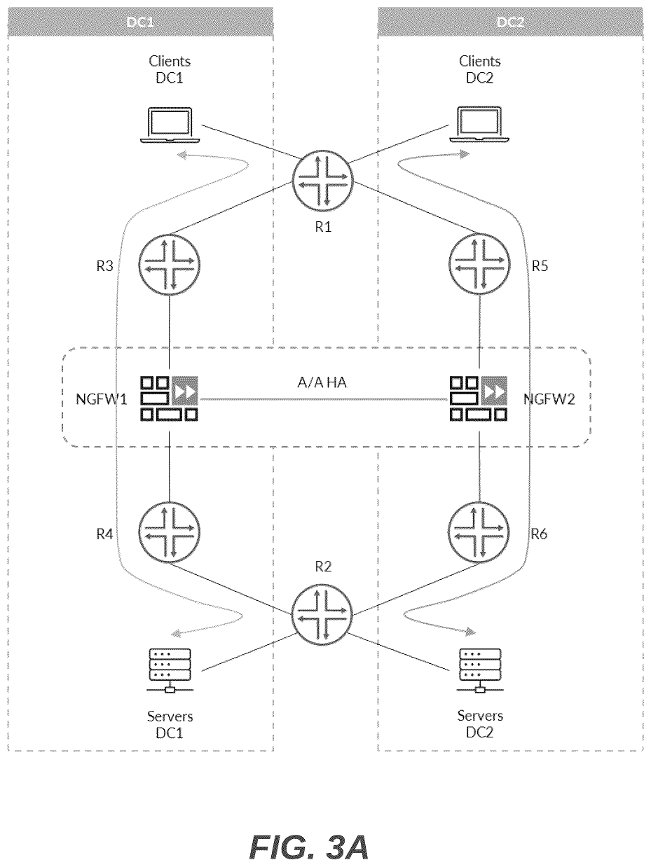

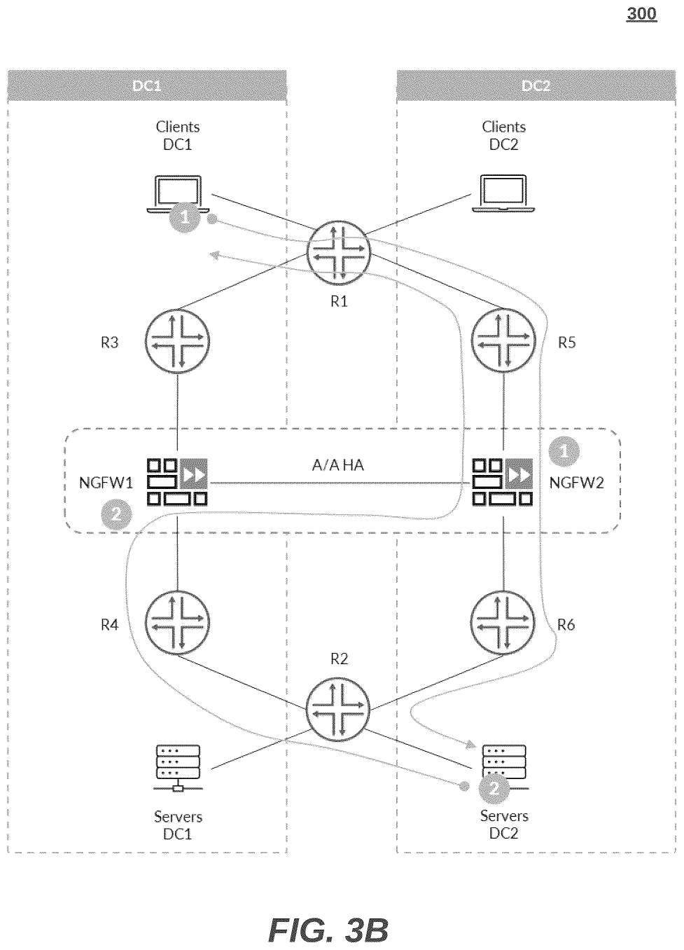

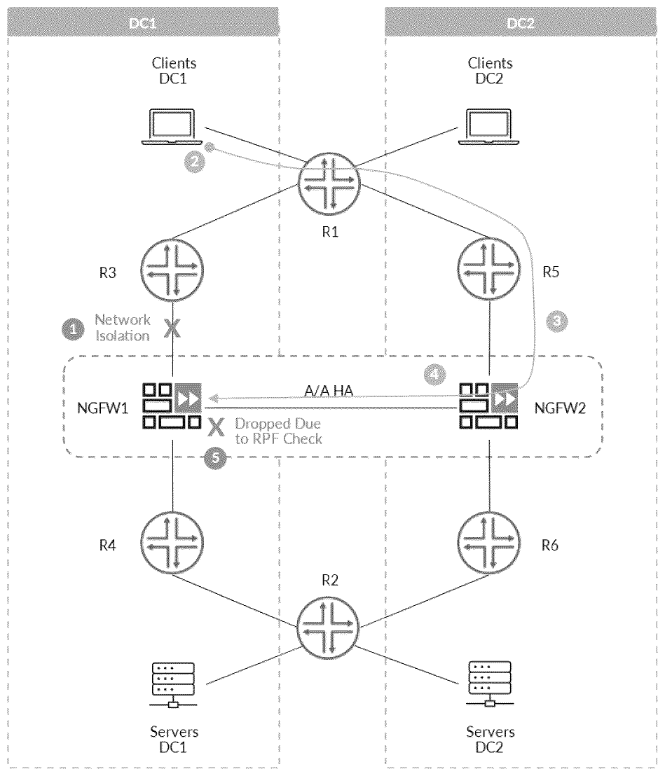

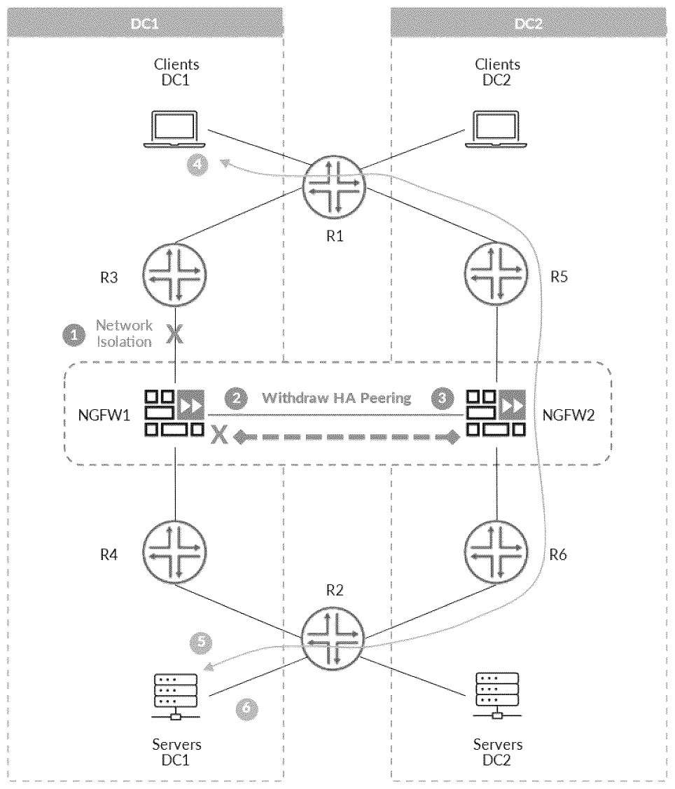

In FIG. 3A, three features are relied upon to describe link reputation. Other embodiments can use different features and different vectors for analysis.

### (1) IP-based URL

Certain phishing attacks are hosted on compromised PCs. These systems might lack DNS entries, and the most straightforward method of identification is through their IP addresses. Since companies seldom use IP addresses to link to web pages, encountering an email with a link containing an IP address (e.g., http://192.168.0.100/amazon change password) raises suspicion of a potential phishing attack. Therefore, whenever a link is detected in an email with an IP address as the host, it is classify the email as having an IP-based URL. This feature is binary in nature. Its value is 0 if it contains IP-based URL, otherwise 1.

### (2) Age of Linked-to Domain Name

Phishers are adapting to avoid detection by steering away from IP-based URLs. Instead, they increasingly employ name-based attacks, wherein a phisher registers a domain name that is either similar or sounds legitimate. However, these domains often have a limited lifespan. Phishers might register them using fraudulently obtained credit cards, leading to potential cancellation by the registrar, or the domain may be identified by monitoring services employed by companies looking out for suspicious registrations (such as those involving their trademarks, as seen with Microsoft). Consequently, phishers have an incentive to utilize these domains shortly after registration. This feature is binary. If the date of domain registration is within N (e.g., 30) days of the email's dispatch, the email is marked with the feature of linking to a “fresh” domain and its value is 0, and otherwise 1.

### (3) Domain Visits

In a straightforward sense, if only a small number of enterprise employees have accessed URLs from the domain linked in the email, we consider a click on the email's link as potentially suspicious. This feature involves tallying the total number of previous visits to any URL sharing the same domain name as the clicked URL. The result is an integer feature.

### B. Sender Reputation

An adversary might be able to spoof a user's ‘From’ name or email address in an email header, yet their writing style may significantly differ from that of the actual account owner. This distinction is captured in the concept of sender reputation, which is assessed through two key features: the abnormality of the HTML <head> content, and the abnormality of the sending server. Importantly, these features are calculated without relying on any private content within the email, focusing instead on metadata and patterns that can indicate a departure from the usual behavior of the legitimate account owner.

(1) Abnormality of HTML <head> Content

Most contemporary email clients provide users the option to use HTML in the message body. HTML can be a potent tool for adversaries to conceal phishing links, making it a common feature in phishing emails. The content within the HTML's <head> tags typically specifies styles and templates for the email body, serving as a clue about the email client used. Regular users often stick to a few email clients for sending messages, while an adversary might not have this knowledge and could use various clients for spear phishing emails. If the <head> content in a new email markedly differs from that in previous emails from the same sender, it raises suspicion that the email could be a spear phishing attempt. A DBSCAN clustering algorithm can calculate abnormality of HTML <head> content. DBSCAN is a density-based and unsupervised machine learning algorithm. It takes original multi-dimensional data or matrix of data distance as inputs and clusters them according to the model parameters-distance algorithm, minimum samples, and epsilon. Based on these parameters, the algorithm determines whether certain values in the dataset are outliers or not.

In our case, we take the <head> content as data and use Levenshtein distance algorithm to calculate similarity of any two data. We choose 2 for minimum samples, and choose 0.75 as epsilon.

### (2) Abnormality of Sending Server

Email headers include a ‘Received from’ section, detailing the server involved in sending or relaying the email at various stages. The last entry under ‘Received from’ usually identifies the originating server, often including its IP address and/or server name. Typically, a user does not frequently switch sending servers, so encountering a new one can be a red flag for suspicious activity. The assessment of whether a sending server is abnormal is binary: if neither the IP nor the server name is found in a previously known list of sending IPs or server names, the feature is marked as 0 (indicating abnormality), otherwise, it's marked as 1 (indicating normality). For instance, if a phishing email originates from the server “23.21.109.197, psm.knowbe4.com”, and the known normal servers for the same sender are [‘172.17.94.53’, ‘172.19.30.61’, ‘fe 80::78f8:7694:9c11:d954’, ‘fe80::78b9:5f97:8cec:b419’][‘FGT-EXCH-MBX134.fortinet-us.com’, ‘FGT-EXCH-MBX132.fortinet-us. com’], then this feature is marked as 0, indicating a deviation from the norm.

### C. Related Anomaly Scoring (RAS) Algorithm

One RAS algorithm can begin by assigning an anomaly score to each email, denoted as E, by calculating the total count of other emails where the feature vector of E is at least as suspicious as the corresponding feature vectors in every dimension. Consequently, the score for E reflects the number of emails that it is at least as suspicious as; emails with higher scores are considered more suspicious than those with lower scores.

The prioritizing module 230 maps the suspicious spear phishing emails by feature vectors and prioritizing according to map position. Next, the relative distance between suspicious emails is checked. In some embodiments, if a relative distance between the specific email and prioritized suspicious emails exceeds a predetermined distance threshold, a security action by the security action module 240 based on spear phishing rules on the filtered highest suspicious emails. On the other hand, if the relative distance does not exceed the predetermined distance threshold, the security action module 240 takes a second security action including forwarding the specific email for standard phishing analysis.

A prioritizing algorithm can be listed as:

```
Score(FV, L): #FV feature vector, L is a feature vector list
  For each feature vector X in L:
    if FV is more suspicious than X in every dimension:
        Increment FV's score by one
Alert(L, N):
  For each feature vector FV in L:
      score(FV, L)
  Sort L by score of each FV's score
  Return the N emails from L with the highest scores
```

The security action module 240 can take actions based on whether spear phishing has been reliably detected. Spear phishing rules can be highly customized for individuals and organizations, as a small subset of policies. Meanwhile, general phishing rules and general malware rules can be more comprehensive and disposed for covering a wide range of malicious attacks. One implementation performs standard phishing and malware detection when spear phishing detection is not reliable. This can include machine learning, artificial intelligence and predictive modeling algorithms that involve training that are more resource intensive with respect to memory, processors, and time. Another implementation applies a spear phishing ruleset on suspicious emails that are clustered with small distances separating each other.

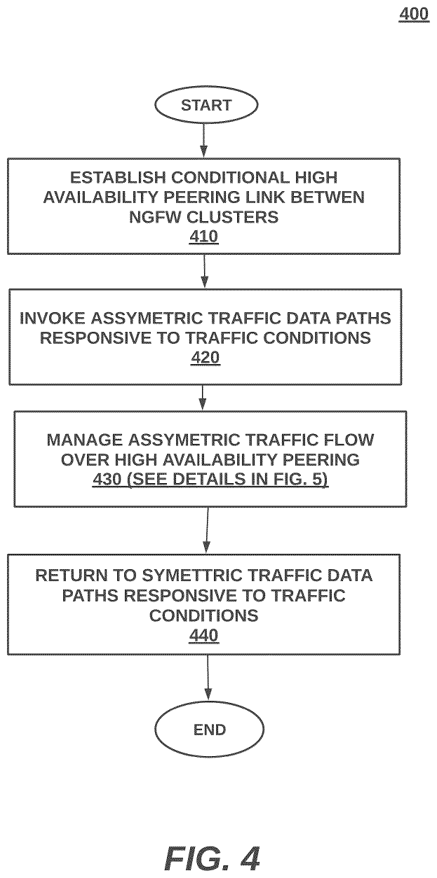

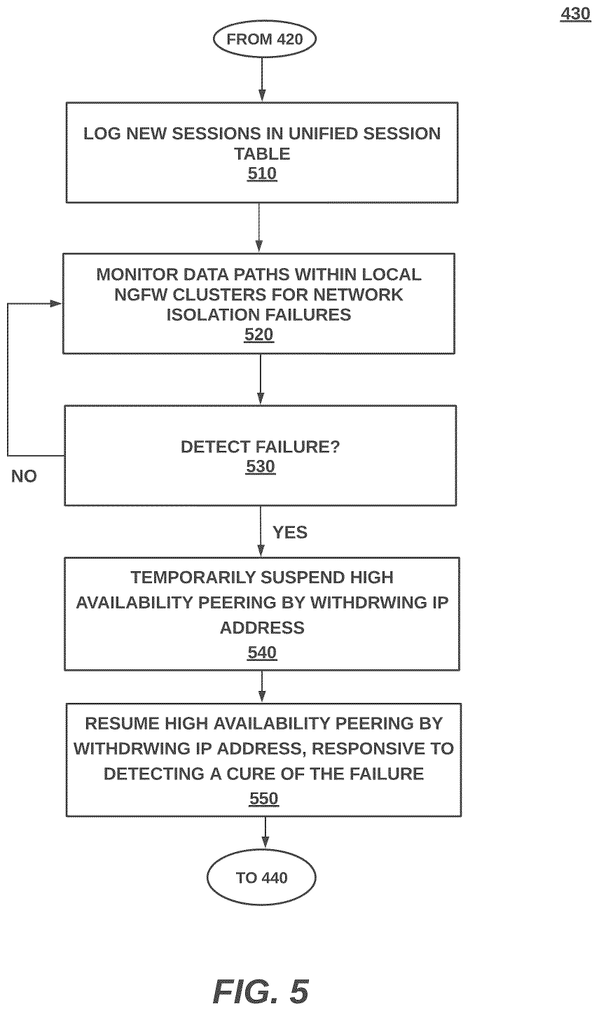

### II. Methods for Accelerated Spear Phishing Detection (FIGS. 4-5)

FIG. 4 is a high-level flow diagram of a method 400 for accelerated detection of spear phishing during email malware detection associated with an enterprise network, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a specific email is received from a stream of incoming emails destined for a specific user of a specific organization. The stream of emails are received over a predetermined sliding window. The sliding window can be defined by one or more parameters, such as time and quantity of emails.

At step 420, accelerated spear phishing detection is performed, as described with respect to FIG. 5.

At step 430, responsive to having a requisite confidence in spear phishing detection results, bypassing standard spear phishing detection processes. Additionally, if spear phishing is detected, a further analysis can provide for a more granular malware analysis using standard processes.

FIG. 5 further details the step 420 of accelerated spear phishing detection. At step 510, emails suspected to include a spear phishing attack from the stream of incoming emails using a RAS are identified. At step 520, the RAS is calculated by identifying feature vectors from the stream of incoming emails [each feature vector includes several dimensions associated with a sender of the email and a link of the email.

At step 530, the suspicious spear phishing emails are mapped by feature vectors and prioritized according to map position. At step 540, relative distances between suspicious emails are checked in case there is excessive clustering.

As a result, if a relative distance between the specific email and prioritized suspicious emails exceeds a predetermined distance threshold, take a security action based on spear phishing rules on the filtered highest suspicious emails. Meanwhile, if the relative distance does not exceed the predetermined distance threshold, take a second security action including forwarding the specific email for standard phishing analysis.

### III. Computing Device for Accelerated Spear Phishing Detection (FIG. 6)

FIG. 6 is a block diagram illustrating a computing device 600 for use in the system 100 of FIG. 1, according to one embodiment. The computing device 600 is a non-limiting example device for implementing each of the components of the system 100, including network security device 110, email server 120, enterprise stations 130A-C and malicious device 140. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VOIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a network security device, on a data communication network, for accelerated detection of spear phishing during email malware detection associated with an enterprise network, the method comprising:
receiving a specific email from a stream of incoming emails destined for a specific user of a specific organization, wherein the stream of emails are received over a predetermined sliding window;
identifying emails suspected to include a spear phishing attack from the stream of incoming emails using a Related Anomaly Score (RAS), wherein the RAS is calculated by identifying feature vectors from the stream of incoming emails associated with a sender of the email and a link of the email;
mapping the suspicious spear phishing emails by feature vectors and prioritizing according to map position;
checking relative distance between suspicious emails, and:
if a relative distance between the specific email and prioritized suspicious emails exceeds a predetermined distance threshold, take a first security action based on spear phishing rules on the filtered highest suspicious emails, and;
if the relative distance does not exceed the predetermined distance threshold, take a second security action including forwarding the specific email for standard phishing analysis.

2. The method of claim 1, wherein the sliding window is defined by at least one of a limited time or a limited volume.

3. The method of claim 1, wherein prioritizing according to map position comprises counting a number of suspicious emails wherein the feature vector is at least as suspicious as the corresponding feature vector in every dimension.

4. The method of claim 1, wherein each of the feature vectors includes several dimensions.

5. The method of claim 1, wherein the relative distance between the specific suspicious emails is defined by mapping positions.

6. A non-transitory computer-readable medium in a network security device, on a data communication network, for accelerated detection of spear phishing during email malware detection associated with an enterprise network, the method comprising:
monitoring receiving a specific email from a stream of incoming emails destined for a specific user of a specific organization, wherein the stream of emails are received over a predetermined sliding window;
identifying emails suspected to include a spear phishing attack from the stream of incoming emails using a Related Anomaly Score (RAS), wherein the RAS is calculated [calculate total count of other emails where the feature vector of E is at least as suspicious as the corresponding feature vectors in every dimension] by identifying feature vectors from the stream of incoming emails [each feature vector includes several dimensions associated with a sender of the email and a link of the email;
mapping the suspicious spear phishing emails by feature vectors and prioritizing according to map position;
checking relative distance between suspicious emails, and:
if a relative distance between the specific email and prioritized suspicious emails exceeds a predetermined distance threshold, take a first security action based on spear phishing rules on the filtered highest suspicious emails, and;
if the relative distance does not exceed the predetermined distance threshold, take a second security action including forwarding the specific email for standard phishing analysis.

7. A network security device, on a data communication network, for accelerated detection of spear phishing during email malware detection associated with an enterprise network comprising:
a processor;
a network interface communicatively coupled to the processor and to a data communication network; and
a memory, communicatively coupled to the processor and storing:
a queueing module to receive a specific email from a stream of incoming emails destined for a specific user of a specific organization, wherein the stream of emails are received over a predetermined sliding window;
an RAS module to identify emails suspected to include a spear phishing attack from the stream of incoming emails using a Related Anomaly Score (RAS), wherein the RAS is calculated [calculate total count of other emails where the feature vector of E is at least as suspicious as the corresponding feature vectors in every dimension] by identifying feature vectors from the stream of incoming emails;
an email prioritizing module to map the suspicious spear phishing emails by feature vectors and prioritizing according to map position;
a clustering module to check relative distance between suspicious emails, and
a security action module to:
if a relative distance between the specific email and prioritized suspicious emails exceeds a predetermined distance threshold, take a first security action based on spear phishing rules on the filtered highest suspicious emails, and;
if the relative distance does not exceed the predetermined distance threshold, take a second security action including forwarding the specific email for standard phishing analysis.
